(19) United States
(12) Patent Application Publication
(10) Pub. No.: US 2024/0204232 A1
(43) Pub. Date: Jun. 20, 2024

(54) BATTERY CELL, BATTERY AND ELECTRICAL DEVICE

(71) Applicant: Dongguan Amperex Technology Limited, Dongguan (CN)

(72) Inventor: Jianpeng CHEN, Dongguan (CN)

(73) Assignee: Dongguan Amperex Technology Limited, Dongguan (CN)

(21) Appl. No.: 18/544,744

(22) Filed: Dec. 19, 2023

(30) Foreign Application Priority Data
Dec. 20, 2022 (CN) 202211641408.8

(51) Int. Cl. H01M 10/04; H01M 4/66; H01M 50/105

(52) U.S. Cl. CPC H01M 10/0413; H01M 4/661; H01M 4/668; H01M 50/105; H01M 2220/20; H01M 2220/30

(57) ABSTRACT

A battery cell includes a positive electrode plate, a separator and a negative electrode plate which are stacked. The positive electrode plate includes a first positive electrode, at least one second positive electrode, a first positive electrode tab and a second positive electrode tab. The first positive electrode plate includes a first positive electrode current collector and a positive electrode active material layer provided thereon. The first positive electrode current collector includes a polymer layer and a conductive layer provided thereon. The second positive electrode plate includes a second positive electrode current collector and a positive electrode active material layer provided thereon. The second positive electrode current collector is made of a metal material. The first positive electrode tab extends outwards from an edge of the first positive electrode plate. The second positive electrode tab extends outwards from an edge of the second positive electrode plate.

### CROSS-REFERENCE TO RELATED APPLICATION

This application claims priority to the Chinese Patent Application Ser. No. 202211641408.8, filed on Dec. 20, 2022, the content of which is incorporated herein by reference in its entirety.

### TECHNICAL FIELD

This application relates to the technical field of batteries, in particular to a battery cell, a battery and an electrical device.

### BACKGROUND

With the increasing application of mobile phones, consumers have increasingly high requirements on mobile phone safety. At present, accidents such as mobile phone fire and smoke in the market generally come from battery damage. Short-circuiting inside the battery causes rapid heat generation, which leads to thermal runaway. As an electrochemical energy body, the battery is critical to mobile phone safety.

According to the analysis of feedback cases of thermal runaway from the market, the main failure modes of batteries are local surface puncturing and local fracture and damage. When a battery is impacted by external forces, the outermost layer is more likely to be punctured, squeezed and broken, resulting in fire due to short-circuiting.

In the process of implementing this application, as found by the inventor, in the existing technologies, in order to improve the safety of batteries, a positive electrode composite current collector technology has been developed. The positive electrode composite current collector is composed of a sandwich structure including a metal layer, a polymer matrix and a metal layer. The use of the positive electrode composite current collector can reduce short-circuiting points in case of damage due to external forces and reduce the short-circuiting thermal power of the positive electrode current collector-negative electrode active material layer. However, adopting a full composite current collector design will significantly increase the price of the battery.

Therefore, it is necessary to provide a battery cell to improve the mechanical safety of the battery under external forces and reduce the cost at the same time.

### SUMMARY

Examples of this application provide a battery cell, a battery and an electrical device, so as to improve the mechanical safety of the battery under external forces and reduce the cost at the same time.

An example of this application provides a battery cell, including an electrode assembly and a housing for accommodating the electrode assembly, the electrode assembly including a positive electrode plate, a negative electrode plate and a separator which are stacked, the separator being provided between the positive electrode plate and the negative electrode plate, where the positive electrode plate includes:

A first positive electrode plate, the first positive electrode plate including a first positive electrode current collector and a first positive electrode active material layer provided on the first positive electrode current collector, the first positive electrode current collector including a polymer layer and a conductive layer, the conductive layer being provided on at least one of two opposite surfaces of the polymer layer in a thickness direction of the electrode assembly:

At least one second positive electrode plate, the second positive electrode plate including a second positive electrode current collector and a second positive electrode active material layer provided on the second positive electrode current collector, the second positive electrode current collector being made of a metal material:

A first positive electrode tab extending outwards from an edge of the first positive electrode plate: and

A second positive electrode tab extending outwards from an edge of the second positive electrode plate. Providing the first positive electrode plate can reduce the risk of short-circuiting in the battery cell due to local surface puncturing, squeezing fracture and the like, and improve the safety of the battery cell. In addition, providing at least one second positive electrode plate can avoid the situation that all electrode plates in the battery cell are the first positive electrode plates, reduce the manufacturing cost of the battery cell and facilitate the popularization.

In some examples, along the stacking direction, an electrode plate on one of outermost sides of the electrode assembly is the first positive electrode plate, which can reduce the risk of short-circuiting in the battery cell due to local surface puncturing, squeezing fracture and the like, and improve the safety of the battery cell.

In some examples, along the stacking direction, an electrode plate on a topmost side of the electrode assembly is the first positive electrode plate: and/or along the stacking direction, an electrode plate on a bottommost side of the electrode assembly is the first positive electrode plate, which can ensure that the electrode plate on the outermost side of the electrode assembly is the first positive electrode plate, reduce the risk of short-circuiting in the battery cell due to local surface puncturing, squeezing fracture and the like, and improve the safety of the battery cell.

In some examples, the electrode assembly includes a first conducting plate; the first positive electrode tab extending outwards from the edge of the each first positive electrode plate and the second positive electrode tab extending outwards from the edge of the each second positive electrode plate converge to connect at a first welding portion, a first end of the first conducting plate is connected to the first welding portion, and a second end of the first conducting plate extends out of the housing. Converging the first positive electrode tab and the second positive electrode tab and then connecting them to the first conducting plate can reduce the welding resistance, improve the reliability of connection between the first positive electrode tab and the first conducting plate, and avoid the problem of “zero” voltage due to weak adhesion since the first positive electrode tab is directly welded to the first conducting plate.

In some examples, the polymer layer includes one or more of a polymer material and a polymer-based composite material: the polymer material comprises one or more selected from the group consisting of polyamide, polyimide, polyethylene terephthalate, polybutylene terephthalate, polyethylene naphthalate, polycarbonate, polyethylene, polypropylene, polypropylene-ethylene, acrylonitrile-butadiene-styrene copolymer, polyvinyl alcohol, polystyrene, polyvinyl chloride, polyvinylidene fluoride, polytetrafluoroethylene, sodium polystyrene sulfonate, polyacetylene, silicon rubber, polyformaldehyde, polyphenylene oxide, polyphenylene sulfide, polyethylene glycol, polysulfur nitride polymer materials, polyphenylene, polypyrrole, polyaniline, polythiophene, polypyridine, cellulose, starch, protein, epoxy resin, phenolic resin, derivatives thereof, crosslinks thereof and copolymers thereof: the polymer-based composite material includes the polymer material and an additive, and the additive includes one or more of a metal material and an inorganic nonmetal material.

In some examples, the conductive layer is a vapor deposition layer or an electroplating layer: the material of the conductive layer comprises one or more selected from the group consisting of copper, copper alloy, nickel, nickel alloy, titanium, titanium alloy, silver and silver alloy: the material of the second positive electrode current collector comprises one or more selected from the group consisting of aluminum, aluminum alloy, copper, copper alloy, nickel, nickel alloy; titanium, titanium alloy, silver and silver alloy.

In some examples, the first positive electrode current collector further includes a protective layer, and the protective layer is provided on at least one of two opposite surfaces of the conductive layer in the thickness direction of the electrode assembly: the protective layer is formed of an inorganic filler, and the inorganic filler comprises one or more selected from the group consisting of aluminum oxide, boehmite, titanium dioxide, zirconium oxide, silicon dioxide and lithium iron phosphate. Providing the protective layer can further reduce the risk of short-circuiting in the battery cell due to squeezing under external forces.

In some examples, the housing is a packaging bag and the packaging bag is an aluminum-plastic film.

An example of this application further provides a battery including the battery cell.

An example of this application further provides an electrical device including the battery and a load, the battery being used for supplying power to the load.

This application has the following beneficial effects:

Compared with the existing technologies, providing the first positive electrode plate in the electrode assembly in the battery cell, the battery and the electrical device provided in the examples of this application can reduce the short-circuiting point during damage under external forces, and reduce the aluminum-anode electrode short-circuiting thermal power, thus reducing the short-circuiting thermal failure at the fracture during heavy object impacting, external force squeezing and puncturing.

In addition, providing at least one second positive electrode plate can avoid the situation that all electrode plates in the battery cell are first positive electrode plates, reduce the manufacturing cost of the battery cell, and facilitate the popularization.

### BRIEF DESCRIPTION OF DRAWINGS

In order to describe the technical solutions of the examples of this application more clearly, the drawings required in the examples of this application will be briefly introduced below. Obviously, the drawings described below are only some examples of this application. Those skilled in the art may obtain other drawings according to these drawings without contributing any inventive labor.

FIG. 1 illustrates a structural schematic diagram of a battery cell according to an example of this application.

FIG. 2 illustrates a partial planar schematic diagram of an electrode assembly in a battery cell illustrated in FIG. 1.

FIG. 3 illustrates a planar schematic diagram of an electrode assembly in a battery cell illustrated in FIG. 1.

FIG. 4 illustrates a planar schematic diagram of an electrode assembly in a battery cell illustrated in FIG. 1.

FIG. 5 illustrates a planar schematic diagram of an electrode assembly in a battery cell illustrated in FIG. 1.

FIG. 6 illustrates a schematic diagram of connection between a positive electrode plate and a first conducting plate in an electrode assembly illustrated in FIG. 3.

FIG. 7 illustrates a schematic diagram of connection between a positive electrode plate and a first conducting plate in an electrode assembly illustrated in FIG. 4.

FIG. 8 illustrates a schematic diagram of connection between a positive electrode plate and a first conducting plate in an electrode assembly illustrated in FIG. 4.

### DETAILED DESCRIPTION

In order to facilitate the understanding of this application, this application will be described below in more detail in combination with the specific examples with reference to the drawings. It should be understood that in a case that a component is expressed as “fixed to”/“connected to” another component, it may be directly on another component, or there may be one or more intermediate components between them; in a case that a component is expressed as “connected” to another component, it may be directly connected to another component, or there may be one or more intermediate components between them. The orientation or position relationships indicated by terms “topmost”, “bottommost” and the like used in this description are based on the orientation or position relationships illustrated in the drawings, are only used for facilitating the description of this application and simplifying the description, instead of indicating or implying that the device or component referred to must have a specific orientation, or be constructed and operated in a specific orientation, and should not be understood as limitations on this application. In addition, the terms “first”, “second” and the like are only used for the purpose of description and should not be understood as indicating or implying relative importance.

Unless otherwise defined, all technical and scientific terms used in this description have the same meanings as those commonly understood by those skilled in the technical field of this application. The terms used in the description of this application are only for the purpose of describing the specific examples and are not intended to limit this application.

In addition, the technical features involved in different examples of this application described below may be combined with each other as long as they do not conflict with each other.

In addition, the technical features involved in different examples of this application described below may be combined with each other as long as they do not conflict with each other.

In the existing technologies, in order to improve the safety performance of batteries, a positive electrode composite current collector technology and a safety coating technology have been developed. The positive electrode composite current collector is usually composed of a sandwich structure including a metal layer, a polymer substrate and a metal layer. The safety coating technology is a technology of coating an inorganic ceramic layer on the positive electrode current collector to provide insulation. Using the positive electrode composite current collector can reduce the short-circuiting point during damage under external forces, and reduce the short-circuiting thermal power of the positive electrode current collector-negative electrode active material layer. The safety coating technology is adopted to protect the positive electrode current collector and avoid the short-circuiting due to the contact between the positive electrode current collector and the negative electrode active material layer. Thus reducing the short-circuiting thermal failure at the fracture during heavy object impacting, external force squeezing and puncturing.

However, in the existing technologies, in order to avoid short-circuiting failure of the battery cell, all positive electrodes adopt composite current collectors, which are expensive. If all positive electrodes adopt composite current collectors, on the one hand, the composite current collector has high impedance, low platform voltage and high price, which is not conducive to popularization. On the other hand, the positive electrode composite current collector faces welding problems. Specifically, since the metal layer on the surface of the single-layer composite current collector is thin and the intermediate substrate is not conductive, when the electrode tab is welded, the mechanical strength of the single thin metal layer is insufficient. Moreover, the heating of the metal layer is uneven, which leads to poor adhesion between the welded electrode tab and the composite current collector, high welding resistance and poor reliability, thus further hindering the popularization and application of the composite current collector.

Therefore, it is necessary to develop a battery cell to improve the mechanical safety of the battery under external forces, and avoid or reduce the problems related to composite current collector welding, impedance, price and the like.

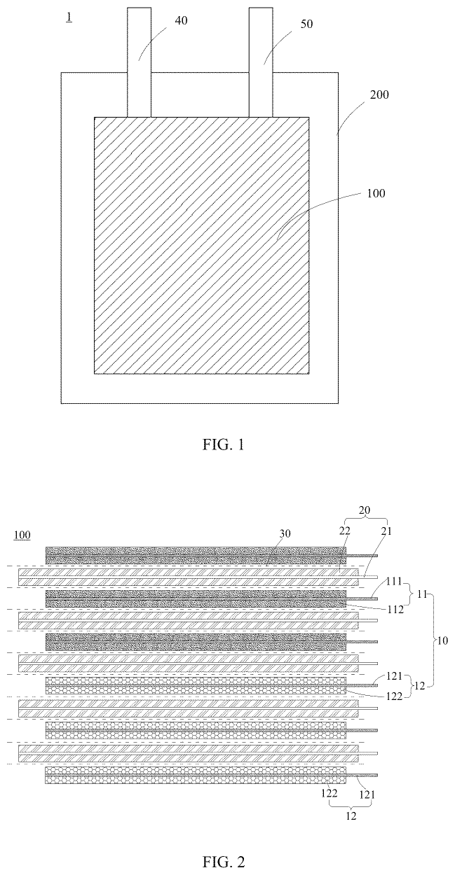

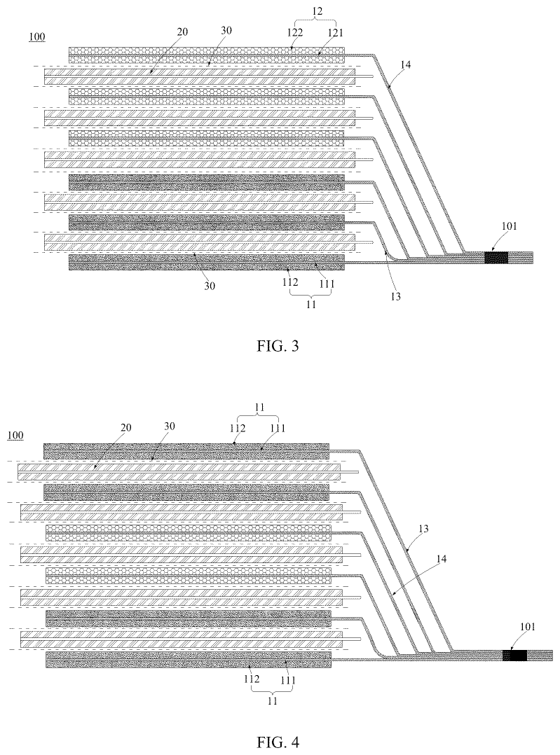

In order to solve the above problems, please refer to FIG. 1, which illustrates a planar schematic diagram of a battery cell 1 according to an example of this application. The battery cell 1 includes an electrode assembly 100 and a housing 200 for accommodating the electrode assembly 100. Please refer to FIG. 2 and FIG. 3, the electrode assembly 100 includes a positive electrode plate 10, a negative electrode plate 20 and a separator 30 which are stacked. The separator 30 is provided between the positive electrode plate 10 and the negative electrode plate 20. The positive electrode plate 10 includes at least one first positive electrode plate 11, at least one second positive electrode plate 12, a first positive electrode tab 13 and a second positive electrode tab 14. The first positive electrode plate 11 includes a first positive electrode current collector 111 and a first positive electrode active material layer 112 provided on the first positive electrode current collector 111. The first positive electrode current collector 111 includes a polymer layer and a conductive layer. The conductive layer is provided on at least one of opposite surfaces of the polymer layer in a thickness direction of the electrode assembly. The second positive electrode plate 12 includes a second positive electrode current collector 121 and a second positive electrode active material layer 122 provided on the second positive electrode current collector 121. The second positive electrode current collector 121 is made of a metal material. The first positive electrode tab 13 extends outwards from an edge of the first positive electrode plate 11. The second positive electrode tab 14 extends outwards from an edge of the second positive electrode plate 12. That is, the first positive electrode tab 13 is formed by protruding from the edge of the first positive electrode plate 11, and the second positive electrode tab 14 is formed by protruding from the edge of the second positive electrode plate 12.

Providing the first positive electrode plate can reduce the risk of short-circuiting in the cell due to local surface puncturing, squeezing fracture and the like, and improve the safety of the cell. In addition, providing at least one second positive electrode can avoid the situation that all electrode plates in the cell are first positive electrodes, reduce the manufacturing cost of the cell and facilitate the popularization.

It can be understood that the separator is provided between the first positive electrode plate and the negative electrode plate, the separator is provided between the second positive electrode plate and the negative electrode plate, and the conductive layer may be provided on one of opposite surfaces of the polymer layer in in the thickness direction or on both of opposite surfaces of the polymer layer in the thickness direction, depending on the actual situation, which is not limited in this application.

It should be noted that the composition of the first positive electrode active material layer 112 and the second positive electrode active material layer 122 mentioned above is the same.

In some examples, in order to improve the safety performance of the battery cell, reduce the short-circuiting thermal failure of the cell at the fracture during heavy object impacting, external force squeezing and puncturing, along the stacking direction, an electrode plate on a outermost side of the electrode assembly is the first positive electrode plate 11. Specifically, referring to FIG. 2, along the stacking direction, an electrode plate on a topmost side of the electrode assembly 100 is the first positive electrode plate 11, or referring to FIG. 3, along the stacking direction, an electrode plate on a bottommost side of the electrode assembly is the first positive electrode plate 11, or referring to FIG. 4, along the stacking direction, both the electrode plates on the topmost side and the bottommost side of the electrode assembly are the first positive electrode plates 11.

In some examples, the polymer layer includes one or more of a polymer material and a polymer-based composite material.

The polymer material comprises one or more selected from the group consisting of polyamide, polyimide, polyester, polyolefin, polyacetylene, siloxane polymer, polyether, polyol, polysulfone, polysaccharide polymer, amino acid polymer, polysulfur nitride, aromatic cyclic polymer, aromatic heterocyclic polymer, epoxy resin, phenolic resin, derivatives thereof, crosslinks thereof and copolymers thereof.

The polyamide polymer material is, for example, polycaprolactam (commonly known as nylon 6), polyhexamethylene adipamide (commonly known as nylon 66), poly-p-phenylene terephthamide (PPTA), or polyisophthaloyl metaphenylene diamine (PMIA). The polyester polymer material is, for example, polyethylene terephthalate (PET), polybutylene terephthalate (PBT), polyethylene naphthalate (PEN), or polycarbonate (PC). The polyolefin polymer material is, for example, polyethylene (PE), polypropylene (PP), or polypropylene (PPE). The derivative of the polyolefin polymer material is, for example, polyvinyl alcohol (PVA), polystyrene (PS), polyvinyl chloride (PVC), polyvinylidene fluoride (PVDF), polytetrafluoroethylene (PTFE), or sodium polystyrene sulfonate (PSS). The polyyne polymer material is, for example, polyacetylene (PA). The siloxane polymer is, for example, silicon rubber. The polyether polymer material is, for example, polyoxymethylene POM), polyphenylene oxide (PPO), or polyphenylene sulfide (PPS). The polyalcohol polymer material is, for example, polyethylene glycol (PEG). The polysaccharide polymer is, for example, cellulose or starch. The amino acid polymer is, for example, protein. The aromatic cyclic polymer is, for example, polystyrene, or poly-p-phenylene. The aromatic heterocyclic polymer is, for example, polypyrrole (PPy), polyaniline (PAN), polythiophene (PT), or polypyridine (PPY). The copolymer of the polyolefin-based polymer and the derivative thereof is, for example, acrylonitrile-butadiene-styrene copolymer (ABS).

The polymer-based composite material includes the polymer material and an additive. The additive includes one or more of a metal material and an inorganic nonmetal material. The metal material comprises, for example, one or more selected from the group consisting of aluminum, aluminum alloy, copper, copper alloy, nickel, nickel alloy, titanium, titanium alloy, iron, iron alloy, silver and silver alloy. The inorganic nonmetal material comprises, for example, one or more selected from the group consisting of carbon-based material, aluminum oxide, silicon dioxide, silicon nitride, silicon carbide, boron nitride, silicate and titanium oxide, or one or more selected from the group consisting of glass material, ceramic material and ceramic composite. The carbon-based material comprises, for example, one or more selected from the group consisting of graphite, superconducting carbon, acetylene black, carbon black, ketjen black, carbon dot, carbon nanotube, graphene and carbon nanofiber.

In some examples, the additive may be a carbon-based material coated with a metal material, such as one or more of graphite powder coated with nickel and carbon fiber coated with nickel.

Since the density of the polymer material and the polymer-based composite is low, the weight of the first positive electrode current collector can be reduced, thus increasing the energy density of the battery cell.

In some examples, the conductive layer may be formed on the polymer layer by at least one means of mechanical rolling, bonding, vapor deposition, electroless plating and electroplating, preferably vapor deposition or electroplating. That is, the conductive layer is preferably a vapor deposition layer or an electroplating layer, so that the close bonding between the conductive layer and the polymer layer can be better achieved. For example, the conductive layer is formed on the polymer layer through vapor deposition, so that the bonding force between the conductive layer and the polymer layer is large, which is conducive to improving the mechanical stability, working stability and service life of the positive electrode current collector. The vapor deposition is preferably physical vapor deposition (PVD). The physical vapor deposition is preferably at least one of evaporation and sputtering. The evaporation is preferably at least one of vacuum evaporation, thermal evaporation deposition and Electron Beam Evaporation Method (EBEM). The sputtering is preferably magnetron sputtering. As an example, the conductive layer is formed by vacuum evaporation, which includes placing a polymer layer that has undergone surface cleaning treatment in a vacuum plating chamber, melting and evaporating a high-purity metal wire in the metal evaporation chamber at high temperature of 1300° C.-000° C., passing the evaporated metal through a cooling system in the vacuum plating chamber, and finally depositing the metal on the polymer layer to form a conductive layer.

The material of the conductive layer comprises one or more selected from the group consisting of copper, copper alloy, nickel, nickel alloy, titanium, titanium alloy, silver and silver alloy.

The material of the second positive electrode current collector comprises one or more selected from the group consisting of aluminum, aluminum alloy, copper, copper alloy, nickel, nickel alloy, titanium, titanium alloy, silver and silver alloy.

It should be noted that the positive electrode active layer includes an active material, a conductive additive and an adhesive. The active material may be a lithium metal compound. The metal may comprise one or more selected from the group consisting of Mn, Fe, Ni, Co, Cr, Ti, Zn, V, Al, Zr, Ce and Mg. The compound comprises, for example, one or more selected from the group consisting of LiMn₂O₄, LiNiO₂, LiCoO₂, LiNi1-yCoyO₂ (0<y<1), LiNiaCobAl_{1-a-b}O₂ (0<a<1, 0<b<1, 0<a+b<1), LiMn₁₋ₘₙNiₘCoₙO₂ (0<m<1, 0<n<1, 0<m+n<1), LiMPO₄ (M may be one or more of Fe, Mn and Co) and Li₃V₂(PO₄)₃. The conductive additive may comprise one or more selected from the group consisting of graphite, conductive carbon black, carbon nanotube, graphene, carbon nanofiber and the like. The adhesive may comprise one or more selected from the group consisting of styrene-butadiene rubber, water-based acrylic resin, carboxymethyl cellulose, polyvinylidene fluoride, polytetrafluoroethylene, polyvinyl alcohol and the like.

In some examples, in order to further reduce the risk of short-circuiting failure in the battery cell due to impacting under external forces, the first positive electrode current collector 111 further includes a protective layer (not shown). The protective layer is provided on at least one of two opposite surfaces of the conductive layer in the thickness direction thereof. The protective layer is formed of an inorganic filler. The inorganic filler includes one or more selected from the group consisting of aluminum oxide, boehmite, titanium dioxide, zirconium oxide, silicon dioxide and lithium iron phosphate.

It can be understood that the protective layer may be provided on one of opposite surfaces of the conductive layer in the thickness direction thereof, or on both of opposite surfaces of the conductive layer in the thickness direction thereof, depending on the actual situation, which is not limited in this application.

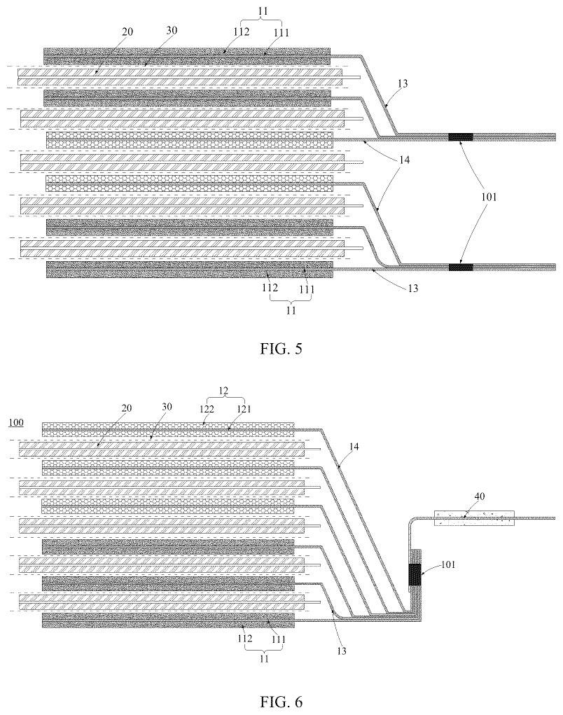

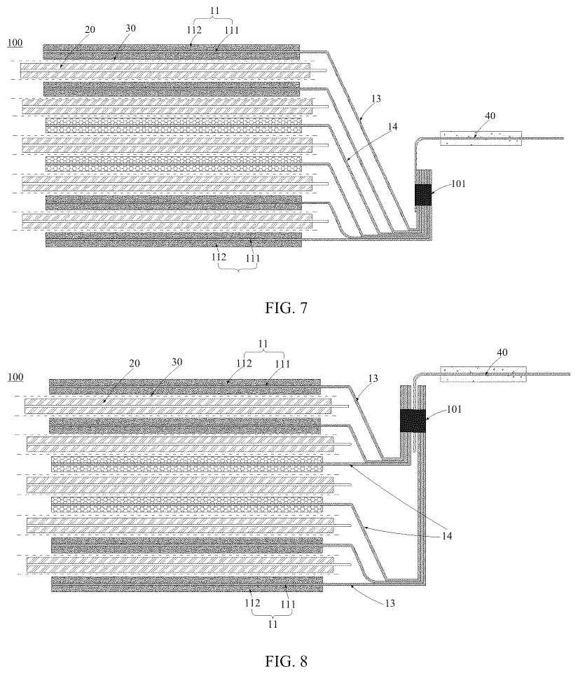

In some examples, referring to FIG. 3 to FIG. 8, the electrode component includes a first conducting plate 40. The first positive electrode tab 13 and the second positive electrode tab 14 are gathered to form a first welding portion 101. A first end of the first conducting plate 40 is connected to the first welding portion 101. A second end of the first conducting plate 40 extends out of the housing 200. Gathering the first positive electrode tab 13 and the second positive electrode tab 14 and then connecting them to the first conducting plate 40 can reduce the welding resistance, improve the reliability of connection between the first positive electrode tab 13 and the first conducting plate 40, and avoid the problem of “zero” voltage due to weak adhesion since the first positive electrode tab 13 is directly welded to the first conducting plate 40.

It should be noted that the first positive electrode tab 13 and the second positive electrode tab 14 being gathered to form a first welding portion 101 refers to that each first positive electrode tab 13 and the second positive electrode tab 14 are gathered and then welded to form a first welding portion, and then the first welding portion 101 is welded to the first conducting plate 40.

In some examples, depending on the number of electrode plates in the electrode assembly, the number of the first welding portions 101 may vary. For example, in FIG. 3 and FIG. 4, the number of the first welding portion 101 is 1, and in FIG. 5, the number of the first welding portions 101 is 2.

In some examples, the electrode assembly 100 further includes third electrode tabs (not shown) and a second conducting plate 50. The third electrode tabs extend outwards from an edge of the negative electrode plate 20. One ends of the third electrode tabs away from the negative electrode plate 20 are gathered to form a second welding portion. A first end of the second conducting plate 50 is connected to the second welding portion. A second end of the second conducting plate 50 extends out of the housing 200.

It can be understood that the first conducting plate 40 is a positive electrode tab, and the second conducting plate 50 is a negative electrode tab.

In some examples, referring to FIG. 2, the negative electrode plate 20 includes a negative electrode current collector 21 and a negative electrode active material layer 22 provided on the negative electrode current collector 21. The negative electrode current collector 21 may be a copper foil. The negative electrode active material in the negative electrode active material layer 22 may comprise one or more selected from the group consisting of artificial graphite, natural graphite, silicon, silicon-carbon composite, lithium titanate and the like. The conductive additive in the negative electrode active material layer may comprise one or more selected from the group consisting of graphite, carbon nanotube, superconducting carbon, graphene, carbon nanofiber and the like. The adhesive in the negative electrode active material layer may comprise one or more selected from the group consisting of styrene-butadiene rubber, water-based acrylic resin, carboxymethyl cellulose, polyvinylidene fluoride, polytetrafluoroethylene, polyvinyl alcohol and the like.

In some examples, the housing 200 may be a polypropylene (PP), aluminum (Al), nylon, aluminum-plastic film or stainless steel housing. In this example, the housing 200 is a packaging bag, and the packaging bag is an aluminum-plastic film.

In some examples, the separator 30 may be a single-layer or multilayer membrane made of one or more of polypropylene (PP), polyethylene (PE), polypropylene and polyethylene composite (PP/PE), non-woven fabric and the like.

An example of this application further provides a battery, which includes the battery cell 1 and electrolyte. The electrolyte may be a mixture of an organic solvent and an electrolyte salt. The organic solvent may comprise one or more selected from the group consisting of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethylene propyl carbonate (EPC), butene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propanoate (PP), methyl butyrate (MB), ethyl butyrate (EB), 1,4-butyrolactone (GBL), sulfolane (SF), dimethyl sulfone (MSM), ethyl methyl sulfone (EMS) and diethyl sulfone (ESE). The electrolyte salt may comprise one or more selected from the group consisting of lithium hexafluorophosphate (LiPF₆), lithium tetrafluoroborate (LiBF₄), lithium perchlorate (LiCIO₄), lithium hexafluoroarsenate (LiAsF₆), lithium bis(fluorosulfonyl) imide (LiFSI), lithium bis(trifluoromethanesulphonyl) imide (LiTFSI), lithium trifluoromethanesulfonate (LiTFS), lithium difluoro(oxalate)borate (LiDFOB), lithium bis(oxalate)borate (LiBOB), lithium difluorophosphate (LiPO₂F₂), lithium difluoro(oxalate)phosphate (LiDFOP) and lithium tetrafluoro(oxalate)phosphate (LiTFOP).

The preparation of lithium-ion batteries will be described below in combination with specific examples. Lithium-ion batteries in Examples 1-21 and Comparative Example are all prepared by adopting the following method. Those skilled in the art can understand that the preparation method described in this application is only exemplary, and any other suitable preparation method falls within the scope of this application.

The preparation processes of the lithium-ion batteries in the examples and the comparative example of this application are as follows:

### Example 1

Preparation of first positive electrode plate: LiCoO₂, conductive carbon black and polyvinylidene fluoride were dispersed in solvent N-methyl-2-pyrrolidone (NMP) according to a weight ratio of 96:2:2. Stirring was performed to form uniform slurry, which was coated on a first positive electrode current collector. In this example, a polymer layer of the first positive electrode current collector was a polyethylene terephthalate (PET) layer, with a thickness of 5 μm. Conductive layers on two sides of the PET layer were aluminum layers. The thickness of each aluminum layer was 1.5 μm. Processes such as drying, laminating and cutting were performed to obtain a first positive electrode plate with a fixed size.

Preparation of second positive electrode plate: LiCoO₂, conductive carbon black and polyvinylidene fluoride were dispersed in solvent N-methyl-2-pyrrolidone (NMP) according to a weight ratio of 96:2:2. Stirring was performed to form uniform slurry, which was coated on an aluminum foil used as a current collector. In this example, the thickness of the aluminum foil was 8 μm. Processes such as drying, laminating and cutting were performed to obtain a second positive electrode plate with a fixed size.

Preparation of negative electrode plate: artificial graphite, conductive carbon black, carboxymethyl cellulose and styrene-butadiene rubber were dispersed in solvent N-methyl-2-pyrrolidone (NMP) according to a weight ratio of 97:1:1:1. Stirring was performed to form uniform slurry, which was coated on a copper foil used as a current collector. In this example, the thickness of the copper foil was 6 μm. Processes such as drying, laminating and cutting were performed to obtain a negative electrode plate with a fixed size.

Preparation of electrolyte: ethylene carbonate (EC), propylene carbonate (PC) and dimethyl carbonate (DMC) were mixed according to a weight ratio of EC:PC:DMC=3:3:3 in an argon atmosphere glovebox with water content less than 10 ppm to obtain an organic solvent mixture. Then, fully dried lithium salt LiPF₆ was dissolved in the organic solvent mixture. Uniform stirring was performed to obtain electrolyte.

Preparation of separator: a polyethylene porous membrane was used as a separator.

### Preparation of Battery:

The first positive electrode plate, the second positive electrode plate, the separator and the negative electrode plate were stacked and combined in an order illustrated in FIG. 2. After stacking, welding was performed. Stacked and welded cells were placed in a housing for encapsulation. The electrolyte was injected into the housing. Processes such as standing, formation, sealing and activation were performed to obtain a lithium-ion secondary battery.

### Example 2

The preparation process of the lithium-ion secondary battery was the same as that in Example 1. A difference was that the first positive electrode plate, the second positive electrode plate, the separator and the negative electrode plate were stacked according to an order illustrated in FIG. 3.

### Example 3

The preparation process of the lithium-ion secondary battery was the same as that in Example 1. A difference was that the first positive electrode plate, the second positive electrode plate, the separator and the negative electrode plate were stacked according to an order illustrated in FIG. 4.

### Example 4

The preparation process of the lithium-ion secondary battery was the same as that in Example 1. A difference was that an electrode plate on a topmost side of the electrode assembly was a first positive electrode plate, the number of which was 1.

### Example 5

The preparation process of the lithium-ion secondary battery was the same as that in Example 2. A difference was that an electrode plate on a bottommost side of the electrode assembly was a first positive electrode plate, the number of which was 1.

### Example 6

The preparation process of the lithium-ion secondary battery was the same as that in Example 3. A difference was that electrode plates on a topmost side and a bottommost side of the electrode assembly were first positive electrode plates, the number of which was 2.

### Example 7

The preparation process of the lithium-ion secondary battery was the same as that in Example 1. Differences were that electrode plates on a topmost side of the electrode assembly were 4 first positive electrode plates, LiMn₂O₄, conductive carbon black and polyvinylidene fluoride were dispersed in solvent N-methyl-2-pyrrolidone (NMP) according to a weight ratio of 96:2:2, and silicon/graphite composite, conductive carbon black, carboxymethyl cellulose and styrene-butadiene rubber were dispersed in solvent N-methyl-2-pyrrolidone (NMP) according to a weight ratio of 97:1:1:1.

### Example 8

The preparation process of the lithium-ion secondary battery was the same as that in Example 2. Differences were that electrode plates on a bottommost side of the electrode assembly were 4 first positive electrode plates, LiMn₂O₄, conductive carbon black and polyvinylidene fluoride were dispersed in solvent N-methyl-2-pyrrolidone (NMP) according to a weight ratio of 96:2:2, and silicon/graphite composite, conductive carbon black, carboxymethyl cellulose and styrene-butadiene rubber were dispersed in solvent N-methyl-2-pyrrolidone (NMP) according to a weight ratio of 97:1:1:1.

### Example 9

The preparation process of the lithium-ion secondary battery was the same as that in Example 3. Differences were that electrode plates on a topmost side of the electrode assembly were 3 first positive electrode plates, LiMn₂O₄, conductive carbon black and polyvinylidene fluoride were dispersed in solvent N-methyl-2-pyrrolidone (NMP) according to a weight ratio of 96:2:2, and silicon/graphite composite, conductive carbon black, carboxymethyl cellulose and styrene-butadiene rubber were dispersed in solvent N-methyl-2-pyrrolidone (NMP) according to a weight ratio of 97:1:1:1.

### Comparative Example 1

Preparation of positive electrode plate: LiCoO₂, conductive carbon black and polyvinylidene fluoride were dispersed in solvent N-methyl-2-pyrrolidone (NMP) according to a weight ratio of 96:2:2. Stirring was performed to form uniform slurry, which was coated on an aluminum foil used as a current collector. In this example, the thickness of the aluminum foil was 8 μm. Processes such as drying, laminating and cutting were performed to obtain a positive electrode plate with a fixed size.

Preparation of negative electrode plate: artificial graphite, conductive carbon black, carboxymethyl cellulose and styrene-butadiene rubber were dispersed in solvent N-methyl-2-pyrrolidone (NMP) according to a weight ratio of 97:1:1:1. Stirring was performed to form uniform slurry, which was coated on a copper foil used as a current collector. In this example, the thickness of the copper foil was 6 μm. Processes such as drying, laminating and cutting were performed to obtain a negative electrode plate with a fixed size.

Preparation of electrolyte: ethylene carbonate (EC), propylene carbonate (PC) and dimethyl carbonate (DMC) were mixed according to a weight ratio of EC:PC:DMC=3:3:3 in an argon atmosphere glovebox with water content less than 10 ppm to obtain an organic solvent mixture. Then, fully dried lithium salt LiPF₆ was dissolved in the organic solvent mixture. Uniform stirring was performed to obtain electrolyte.

Preparation of separator: a polyethylene porous membrane was used as a separator.

### Preparation of Battery:

The positive electrode plate, the separator and the negative electrode plate were stacked and combined. The separator was provided between the positive electrode plate and the negative electrode plate. After stacking, positive electrode tabs extending from the positive electrode plate were gathered. Then, first welding was performed to form a welding point. Then, one end of a first conducting plate was welded with the welding point again. The other end of the first conducting plate extended out of the housing. Then, the stacked and welded cells were placed in a housing for encapsulation. The electrolyte was injected into the housing. Processes such as standing, formation, sealing and activation were performed to obtain a lithium-ion secondary battery.

### Comparative Example 2

Preparation of first positive electrode plate: LiCoO₂, conductive carbon black and polyvinylidene fluoride were dispersed in solvent N-methyl-2-pyrrolidone (NMP) according to a weight ratio of 96:2:2. Stirring was performed to form uniform slurry, which was coated on a first positive electrode current collector. Processes such as drying, laminating and cutting were performed to obtain a first positive electrode plate with a fixed size. A polymer layer of the first positive electrode current collector was a polyethylene terephthalate (PET) layer, with a thickness of 5 μm. Conductive layers on two sides of the PET layer were aluminum layers. The thickness of each aluminum layer was 1.5 μm.

Preparation of negative electrode plate: artificial graphite, conductive carbon black, carboxymethyl cellulose and styrene-butadiene rubber were dispersed in solvent N-methyl-2-pyrrolidone (NMP) according to a weight ratio of 97:1:1:1. Stirring was performed to form uniform slurry, which was coated on a copper foil used as a current collector. In this example, the thickness of the copper foil was 6 μm. Processes such as drying, laminating and cutting were performed to obtain a negative electrode plate with a fixed size.

Preparation of electrolyte: ethylene carbonate (EC), propylene carbonate (PC) and dimethyl carbonate (DMC) were mixed according to a weight ratio of EC:PC:DMC=3:3:3 in an argon atmosphere glovebox with water content less than 10 ppm to obtain an organic solvent mixture. Then, fully dried lithium salt LiPF₆ was dissolved in the organic solvent mixture. Uniform stirring was performed to obtain electrolyte.

Preparation of separator: a polyethylene porous membrane was used as a separator.

### Preparation of Battery:

The first positive electrode plate, the separator and the negative electrode plate were stacked and combined. After stacking, first positive electrode tabs extending from the first positive electrode plate were gathered. Then, first welding was performed to form a welding point. Then, one end of a first conducting plate was welded with the welding point again. The other end of the first conducting plate extended out of the housing. Then, the stacked and welded cells were placed in a housing for encapsulation. The electrolyte was injected into the housing. Processes such as standing, formation, sealing and activation were performed to obtain a lithium-ion secondary battery.

It should be noted that the fixed size mentioned above may be limited according to the actual situation. In the examples of this application, the sizes of the negative electrode plate, the first positive electrode plate, the second positive electrode plate and the positive electrode plate are all the same.

### Performance Testing:

Heavy impact testing was performed on the batteries in Examples 1-9 and Comparative Examples 1-2. The testing method was as follows: 20 batteries were prepared for each of examples and comparative examples. The batteries in the examples and comparative examples were placed on a test bench. A round rod with a diameter of 10-20 mm was placed at a center of a width surface of each battery. The round rod was perpendicular to a long axis of the battery. A 9.1±0.1 kg heavy hammer was vertically dropped in a free state from a height of 610±25 mm to an intersection of the round rod and the battery. In a case that the battery did not catch fire and explode, it was determined that it passed. The testing results are shown in Table 1.

TABLE 1

| | Position of first | | | |
|---|---|---|---|---|
| | positive | Positive electrode | Negative electrode | Impact test |
| | electrode plate | active layer | plate | pass rate |
| Example 1 | 3 first positive | LiCoO₂, conductive | Copper foil, artificial | 50% |
| | electrode plates | carbon black, | graphite, conductive | |
| | at the topmost | polyvinylidene | carbon black, | |
| | layer | fluoride | carboxymethyl | |
| | | | cellulose, styrene- | |
| | | | butadiene rubber | |
| Example 2 | 3 first positive | The same as | The same as | 50% |
| | electrode plates | Example 1 | Example 1 | |
| | at the | | | |
| | bottommost | | | |
| | layer | | | |
| Example 3 | 2 first positive | The same as | The same as | 100% |
| | electrode plates | Example 1 | Example 1 | |
| | at each of the | | | |
| | topmost layer | | | |
| | and the | | | |
| | bottommost | | | |
| | layer | | | |
| Example 4 | 1 first positive | The same as | The same as | 30% |
| | electrode plate at | Example 1 | Example 1 | |
| | the topmost layer | | | |
| Example 5 | 1 first positive | The same as | The same as | 30% |
| | electrode plate at | Example 1 | Example 1 | |
| | the bottommost | | | |
| | layer | | | |
| Example 6 | 1 first positive | The same as | The same as | 60% |
| | electrode plate at | Example 1 | Example 1 | |
| | each of the | | | |
| | topmost layer | | | |
| | and the | | | |
| | bottommost | | | |
| | layer | | | |
| Example 7 | 4 first positive | LiCoO₂ was | Artificial graphite | 60% |
| | electrode plates | replaced with other | was replaced with | |
| | at the topmost | compounds such as | silicon/graphite | |
| | layer | LiMn₂O₄ on the | composites on the | |
| | | basis of Example 1. | basis of Example 1. | |
| Example 8 | 4 first positive | LiCoO₂ was | Artificial graphite | 60% |
| | electrode plates | replaced with other | was replaced with | |
| | at the | compounds such as | silicon/graphite | |
| | bottommost | LiMn₂O₄ on the | composites on the | |
| | layer | basis of Example 1. | basis of Example 1. | |
| Example 9 | 3 first positive | LiCoO₂ was | Artificial graphite | 100% |
| | electrode plates | replaced with other | was replaced with | |
| | at each of the | compounds such as | silicon/graphite | |
| | topmost layer | LiMn₂O₄ on the | composites on the | |
| | and the | basis of Example 1. | basis of Example 1. | |
| | bottommost | | | |
| | layer | | | |
| Comparative | All positive | The same as | The same as | 0% |
| Example 1 | electrode plates | Example 1 | Example 1 | |
| | in the electrode | | | |
| | assembly were | | | |
| | second positive | | | |
| | electrode plates | | | |
| Comparative | All positive | The same as | The same as | 100% |
| Example 2 | electrode plates | Example 1 | Example 1 | |
| | in the electrode | | | |
| | assembly were | | | |
| | first positive | | | |
| | electrode plates | | | |

Table 1 shows the performance testing results of Comparative Examples 1-2 and Examples 1-9.

By comparing Comparative Examples 1 and 2 with Examples 1-9, it can be seen that the batteries with the first positive electrode plate(s) have a higher pass rate in the impact test than the batteries without the first positive electrode plate.

By comparing Examples 1, 4 and 7 with Examples 2, 5 and 8 and with Examples 3, 6 and 9, it can be seen that the more layers of the first positive electrode plates located on the outermost side of the electrode assembly, the higher the impact test pass rate of the battery, that is, the lower the short-circuiting thermal failure of the battery during heavy object impacting, external force squeezing and puncturing.

By comparing Example 1 with Example 2, Example 4, Example 5, Example 7 and Example 8, it can be seen that along the stacking direction, as long as the electrode plate provided on the outermost side of the electrode assembly is the first positive electrode plate, it can effectively reduce the risk of short-circuiting thermal failure of the battery at the fracture during heavy object impacting, external force squeezing and puncturing.

By comparing Example 3 with Example 6 and Example 9, it can be seen that when the electrode plates on the topmost side and the bottommost side of the electrode assembly are the first positive electrode plates, the more the first positive electrode plates, the higher the impact test pass rate of the battery, that is, the lower the short-circuiting thermal failure of the battery during heavy object impacting, external force squeezing and puncturing.

By comparing Examples 1-3 with Examples 4-6, it can be seen that along the stacking direction of the cells, the batteries with the electrode plates on the topmost side and the bottommost side of the electrode assembly being the first positive electrode plates have a higher impact test pass rate than the batteries with the electrode plates on the topmost side only of the electrode assembly being the first positive electrode plates or the electrode plates on the bottommost side only of the electrode assembly being the first positive electrode plates.

An example of this application further provides an electrical device, which includes the battery and a load. The battery is used for supplying power to the load. The electrical device may be a mobile phone, a vehicle, a tablet computer, or the like.

In the cell, the battery and the electrical device according to the examples of this application, providing the first positive electrode plate in the electrode assembly in the cell, the battery and the electrical device provided in the examples of this application can reduce the short-circuiting point during damage under external forces, and reduce the aluminum-anode electrode short-circuiting thermal power, thus reducing the short-circuiting thermal failure at the fracture during heavy object impacting, external force squeezing and puncturing. In addition, providing at least one second positive electrode plate can avoid the situation that all electrode plates in the cell are first positive electrode plates, reduce the manufacturing cost of the cell, and facilitate the popularization.

Finally, it should be noted that the examples are only used for describing the technical solution of this application, instead of limiting it. Under the concept of this application, the technical features in the above examples or different examples may also be combined, the steps may be implemented in any order, and there are many other changes in different aspects of this application as described above, which are not provided in detail for simplicity. Although this application has been described in detail with reference to the examples, those skilled in the art should understand that they can still make modifications to the technical solutions recorded in the examples or make equivalent replacements to some of the technical features, which, however, do not make the essence of the corresponding technical solution deviate from the scope of protection of this application.

1. A battery cell, comprising: an electrode assembly and a housing for accommodating the electrode assembly; the electrode assembly comprising a positive electrode plate, a negative electrode plate and a separator stacked together along a stacking direction; the separator being provided between the positive electrode plate and the negative electrode plate;
wherein the positive electrode plate comprises at least one first positive electrode plate, at least one second positive electrode plate, a first positive electrode tab extending outwards from an edge of each first positive electrode plate, and a second positive electrode tab extending outwards from an edge of each second positive electrode plate;
the each first positive electrode plate comprising a first positive electrode current collector and a first positive electrode active material layer provided on the first positive electrode current collector, the first positive electrode current collector comprising a polymer layer and a conductive layer, the conductive layer being provided on at least one of two opposite surfaces of the polymer layer in a thickness direction of the electrode assembly;
the each second positive electrode plate comprising a second positive electrode current collector and a second positive electrode active material layer provided on the second positive electrode current collector, the second positive electrode current collector being made of a metal material.

2. The battery cell according to claim 1, wherein,
along the stacking direction, an electrode plate on one of outermost sides of the electrode assembly is the first positive electrode plate.

3. The battery cell according to claim 2, wherein,
along the stacking direction, electrode plates on both of the outermost sides of the electrode assembly are the first positive electrode plates.

4. The battery cell according to claim 1, wherein the electrode assembly comprises a first conducting plate:
the first positive electrode tab extending outwards from the edge of the each first positive electrode plate and the second positive electrode tab extending outwards from the edge of the each second positive electrode plate converge to connect at a first welding portion: a first end of the first conducting plate is connected to the first welding portion, and a second end of the first conducting plate extends out of the housing.

5. The battery cell according to claim 1, wherein the polymer layer comprises one or more of a polymer material or a polymer-based composite material;
the polymer material comprises one or more selected from the group consisting of polyamide, polyimide, polyethylene terephthalate, polybutylene terephthalate, polyethylene naphthalate, polycarbonate, polyethylene, polypropylene, polypropylene-ethylene, acrylonitrile-butadiene-styrene copolymer, polyvinyl alcohol, polystyrene, polyvinyl chloride, polyvinylidene fluoride, polytetrafluoroethylene, sodium polystyrene sulfonate, polyacetylene, silicon rubber, polyformaldehyde, polyphenylene oxide, polyphenylene sulfide, polyethylene glycol, polysulfur nitride polymer materials, polyphenylene, polypyrrole, polyaniline, polythiophene, polypyridine, cellulose, starch, protein, epoxy resin, phenolic resin, derivatives thereof, crosslinks thereof and copolymers thereof;
the polymer-based composite material comprises the polymer material and an additive, and the additive comprises one or more of a metal material or an inorganic nonmetal material.

6. The battery cell according to claim 1, wherein,
the conductive layer is a vapor deposition layer or an electroplating layer;
the material of the conductive layer comprises one or more selected from the group consisting of copper, copper alloy, nickel, nickel alloy, titanium, titanium alloy, silver and silver alloy;
the material of the second positive electrode current collector comprises one or more selected from the group consisting of aluminum, aluminum alloy, copper, copper alloy, nickel, nickel alloy, titanium, titanium alloy, silver and silver alloy.

7. The battery cell according to claim 1, wherein,
the first positive electrode current collector further comprises a protective layer, and the protective layer is provided on at least one of two opposite surfaces of the conductive layer in the thickness direction of the electrode assembly;
the protective layer is formed of an inorganic filler, and the inorganic filler comprises one or more selected from the group consisting of aluminum oxide, boehmite, titanium dioxide, zirconium oxide, silicon dioxide and lithium iron phosphate.

8. The battery cell according to claim 1, wherein,
the housing is a packaging bag and the packaging bag is an aluminum-plastic film.

9. A battery, comprising a battery cell; the battery cell comprising an electrode assembly and a housing for accommodating the electrode assembly; the electrode assembly comprising a positive electrode plate, a negative electrode plate and a separator stacked together along a stacking direction; the separator being provided between the positive electrode plate and the negative electrode plate;
wherein the positive electrode plate comprises at least one first positive electrode plate, at least one second positive electrode plate, a first positive electrode tab extending outwards from an edge of each first positive electrode plate, and a second positive electrode tab extending outwards from an edge of each second positive electrode plate;
the each first positive electrode plate comprising a first positive electrode current collector and a first positive electrode active material layer provided on the first positive electrode current collector, the first positive electrode current collector comprising a polymer layer and a conductive layer, the conductive layer being provided on at least one of two opposite surfaces of the polymer layer in a thickness direction of the electrode assembly;
the each second positive electrode plate comprising a second positive electrode current collector and a second positive electrode active material layer provided on the second positive electrode current collector, the second positive electrode current collector being made of a metal material.

10. The battery according to claim 9, wherein,
along the stacking direction, an electrode plate on one of outermost sides of the electrode assembly is the first positive electrode plate.

11. The battery according to claim 10, wherein,
along the stacking direction, electrode plates on both of the outermost sides of the electrode assembly are the first positive electrode plates.

12. The battery according to claim 9, wherein the electrode assembly comprises a first conducting plate;
the first positive electrode tab extending outwards from the edge of the each first positive electrode plate and the second positive electrode tab extending outwards from the edge of the each second positive electrode plate converge to connect at a first welding portion: a first end of the first conducting plate is connected to the first welding portion, and a second end of the first conducting plate extends out of the housing.

13. The battery according to claim 9, wherein the polymer layer comprises one or more of a polymer material or a polymer-based composite material;
the polymer material comprises one or more selected from the group consisting of polyamide, polyimide, polyethylene terephthalate, polybutylene terephthalate, polyethylene naphthalate, polycarbonate, polyethylene, polypropylene, polypropylene-ethylene, acrylonitrile-butadiene-styrene copolymer, polyvinyl alcohol, polystyrene, polyvinyl chloride, polyvinylidene fluoride, polytetrafluoroethylene, sodium polystyrene sulfonate, polyacetylene, silicon rubber, polyformaldehyde, polyphenylene oxide, polyphenylene sulfide, polyethylene glycol, polysulfur nitride polymer materials, polyphenylene, polypyrrole, polyaniline, polythiophene, polypyridine, cellulose, starch, protein, epoxy resin, phenolic resin, derivatives thereof, crosslinks thereof and copolymers thereof;
the polymer-based composite material comprises the polymer material and an additive, and the additive comprises one or more of a metal material or an inorganic nonmetal material.

14. The battery according to claim 9, wherein,
the conductive layer is a vapor deposition layer or an electroplating layer;
the material of the conductive layer comprises one or more selected from the group consisting of copper, copper alloy, nickel, nickel alloy, titanium, titanium alloy, silver and silver alloy;
the material of the second positive electrode current collector comprises one or more selected from the group consisting of aluminum, aluminum alloy, copper, copper alloy, nickel, nickel alloy, titanium, titanium alloy, silver and silver alloy.

15. The battery according to claim 9, wherein,
the first positive electrode current collector further comprises a protective layer, and the protective layer is provided on at least one of two opposite surfaces of the conductive layer in the thickness direction of the electrode assembly;
the protective layer is formed of an inorganic filler, and the inorganic filler comprises one or more selected from the group consisting of aluminum oxide, boehmite, titanium dioxide, zirconium oxide, silicon dioxide and lithium iron phosphate.

16. The battery according to claim 9, wherein,
the housing is a packaging bag and the packaging bag is an aluminum-plastic film.

17. An electrical device, comprising a battery and a load, the battery being used for supplying power to the load: the battery comprising a battery cell; the battery cell comprising an electrode assembly and a housing for accommodating the electrode assembly: the electrode assembly comprising a positive electrode plate, a negative electrode plate and a separator stacked together along a stacking direction; the separator being provided between the positive electrode plate and the negative electrode plate;
wherein the positive electrode plate comprises at least one first positive electrode plate, at least one second positive electrode plate, a first positive electrode tab extending outwards from an edge of each first positive electrode plate, and a second positive electrode tab extending outwards from an edge of each second positive electrode plate;
the each first positive electrode plate comprising a first positive electrode current collector and a first positive electrode active material layer provided on the first positive electrode current collector, the first positive electrode current collector comprising a polymer layer and a conductive layer, the conductive layer being provided on at least one of two opposite surfaces of the polymer layer in a thickness direction of the electrode assembly;
the each second positive electrode plate comprising a second positive electrode current collector and a second positive electrode active material layer provided on the second positive electrode current collector, the second positive electrode current collector being made of a metal material.

18. The electrical device according to claim 17, wherein,
along the stacking direction, an electrode plate on one of outermost sides of the electrode assembly is the first positive electrode plate.

19. The electrical device according to claim 18, wherein,
along the stacking direction, electrode plates on both of the outermost sides of the electrode assembly are the first positive electrode plates.

20. The electrical device according to claim 17, wherein the electrode assembly comprises a first conducting plate;
the first positive electrode tab extending outwards from the edge of the each first positive electrode plate and the second positive electrode tab extending outwards from the edge of the each second positive electrode plate converge to connect at a first welding portion; a first end of the first conducting plate is connected to the first welding portion, and a second end of the first conducting plate extends out of the housing.
